(19) United States
(12) Patent Application Publication
(10) Pub. No.: US 2008/0276311 A1
(43) Pub. Date: Nov. 6, 2008

(54) Method, Apparatus, and software for a multi-phase packet filter for internet access

(76) Inventor: Stefan Kassovic, San Jose, CA (US)

Correspondence Address: DEBORAH W. WENOCUR, 4057 AMARANTA AVE., PALO ALTO, CA, 94306, US

(21) Appl. No.: 12/151,097

(22) Filed: May 1, 2008

Related U.S. Application Data
(60) Provisional application No. 60/915,958, filed on May 4, 2007.

(51) Int. Cl. G06F 21/00; G06F 15/16

(52) U.S. Cl. 726/11

(57) ABSTRACT

A Time Gate Packet Filter (TGPF) for controlling data flow and Internet Access in a small environment. The TGPF is self-contained, simple to use, does not require IT expertise, and requires no software installation. The TGPF utilizes multi-phase filtering to control network access based on: types of sites, specific sites, types of services that can be accessed, source and destination, time of day, and day of week.

### CROSS REFERENCE TO RELATED APPLICATION

The present invention is related to U.S. Provisional Application No. 60/915,958, filed May 4, 2007, and claims priority thereto. Provisional application 60/915,958 is hereby incorporated by reference in its entirety.

### FIELD OF THE INVENTION

The present invention pertains or relates to a firewall, and in particular to a multi-phase packet filter for secure and controlled access to the Internet.

### BACKGROUND OF THE INVENTION

There are many dangers and issues associated with the Internet and Internet connection. Some examples include: aggressive peer-to-peer (P2P) interactions, on-line gaming addiction, and Internet Harrassment. It can be difficult, though desirable, for parents to have control over their childrens' Internet usage, such as the use of chat rooms or instant messaging. One method for attaining this control is to filter site access, similarly to the blocking of undesired TV channels. Two types of filtering may occur: first, a particular web site or URL or IP may be blocked, such as YouTube or MySpace. An alternative type of filtering relates to situations where the site is a portal for an application, such as games or chat rooms. The application may utilize multiple protocols, such as TCP or UDP. In such cases, the filtering tends to be more complex, and may involve blocking one or more protocols in order to prevent use of the application. It may also involve blocking particular ports associated with the type of application. For example, IM games are associated with a particular port, as are chat rooms.

Software solutions to certain of these issues (i.e., site filtering, daily time limits) include: Net Nanny from ContentWatch, Inc., CIBERsitter from Solid Oak Software, Inc., and CyberPatrol from CyberPatrol, LLC. The currently available packages must be installed separately on each PC, require some technical expertise to install and maintain, and have been found to have a tendency to make the PC inoperable, presumably due to inappropriate filtering. Some hardware approaches are provided by: Linksys from Cisco Systems, Netgear from Netgear, and D-Link from D-Link Corporation/D-Link Systems, Inc. These approaches have many drawbacks. In each case the site filtering must be configured site-by-site by the user, which is difficult and requires a lot of technical expertise. Each requires a personal computer with monitor, serial cable or network connection to configure.

As a result, the available software and hardware systems for site filtering in a small environment are fraught with problems and tend not to be user-friendly. A solution to these problems should prove to be highly desirable.

An example of a currently available filter is described in U.S. Pat. No. 6,925,572, titled “Firewall with Two-Phase Filtering”, issued Aug. 2, 2005. It discloses a partial solution to the problem in the form of a firewall. A firewall is in general software within a router, i.e., located between a private network or machine and the internet gateway for the private device or network. A request for information from the internet is routed through the firewall, and information received from the internet is first received at the firewall before being transmitted or distributed to the private device or network. The communication protocols used are specific to the site or application. The firewall of U.S. Pat. No. 6,925,572 has two simple phases: the first phase is verification that the protocol is allowed and that the length of the request does not exceed the allowed maximum for the command. In phase 2, which is a specialized phase particular to the protocol of the request, the request is filtered to verify one or more of: the source, the destination, and the content of the request. The firewall of U.S. Pat. No. 6,925,572 is specifically designed to prevent private or local networks from malicious attacks from the Internet, and is particularly useful in a commercial or business environment. It is not installed on individual computers since it is on the router, but is difficult to configure and not user-friendly.

For home or other small environment applications, additional criteria become important. These may include filtering which computers may have Internet access, or at what times of the day a given computer may have Internet access. Furthermore, ease of use and portability become factors. As a result, existing firewalls in the art, which target Internet attacks, do not provide full functionality in a small environment such as a home or a small business or school.

### SUMMARY OF THE INVENTION

It is therefore an object of this invention to provide a Time Gate Packet Filter (TGPF) designed for application in a small environment such as a home, a small business, or a small school.

It is a further object of this invention to provide a Time Gate Packet Filter (TGPF) designed for application in an environment where IT expertise is not required, such as in a home or in a small business or in a school.

It is a further object of this invention to provide a Time Gate Packet Filter (TGPF) which is self-contained, simple to use, and a true “plug and play”, i.e., no software has to be installed.

It is a further object of this invention to provide a Time Gate Packet Filter (TGPF) which controls network access based on: types of sites, specific sites, types of services, source and destination, time of day, and day of week, i.e., time schedule.

It is a further object of this invention to provide a Time Gate Packet Filter (TGPF) with multi-phase filtering for secure and controlled access to the Internet.

These objects are met by the system and method outlined hereinafter.

### BRIEF DESCRIPTION OF THE DRAWINGS

FIG. 1 illustrates a functional diagram of a standard configuration of a computer network including the TGPF of the present invention.

FIG. 2 illustrates a functional diagram of alternate current and projected configurations of a computer network including the TGPF of the present invention.

FIG. 3 is a flow diagram of the multi phase filtering of the present invention.

FIG. 4 is a flow diagram of the time phase filtering.

FIG. 5 illustrates an exemplary configuration of the TGPF as it controls access to different types of data flow.

FIG. 6a illustrates an exemplary configuration of the TGPF for family usage.

FIG. 6b illustrates exemplary settings corresponding to the family gate configuration.

FIG. 7 is a flow chart showing the usage and modification of the menu.

FIG. 8a shows a front view of the hardware components of the inventive box.

FIG. 8b shows the programming screen interface of the inventive box.

### DETAILED DESCRIPTION OF THE INVENTION

The inventive system relates to a firewall with multi-phase filtering, Typically a firewall is located between a user computer or an internal network such as a Local Area Network (LAN) and an external network such as the Internet that can pose risks to the internal network. The firewall of the present invention is generally used to provide controlled and secure access to the Internet. It may also be used to segment networks into secured and unsecured portions, or to apply different levels of security or policy to different parts of the network.

The inventive filter/firewall system is a stand-alone unit which does not impact the operation of the PC which may be connected on the LAN. It does not require technical expertise to install or operate or configure: the user performs a simple configuration on the box itself. A second advantage of the inventive system is a time filtering configuration, which will be described hereinafter. The inventive system can be used, for a specific computer or for the complete LAN of a house or other small environment, i.e., for several computers.

Configuring the system is accomplished according to the following process:

The user selects or provides a set of specific sites to be subject to blocking, such as YouTube or MySpace or FaceBook.

The user further selects a set of categories subject to blocking, such as computer games, chat rooms, etc.

The user further enters a time schedule which determines which sites or categories will be blocked from which computers during which time periods. This may include daily or weekly periods, e.g., children may be permitted different periods for internet access during the weekend than during the weekdays.

The user subscribes to a service which maintains and updates a list of sites and protocols/ports subject to blocking, according to pre-defined categories. The user can add or subtract specific sites whenever necessary, and user-defined categories may be implemented.

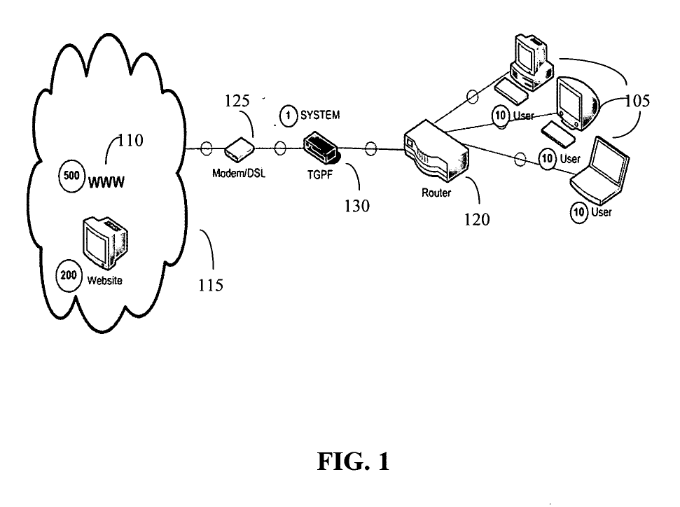

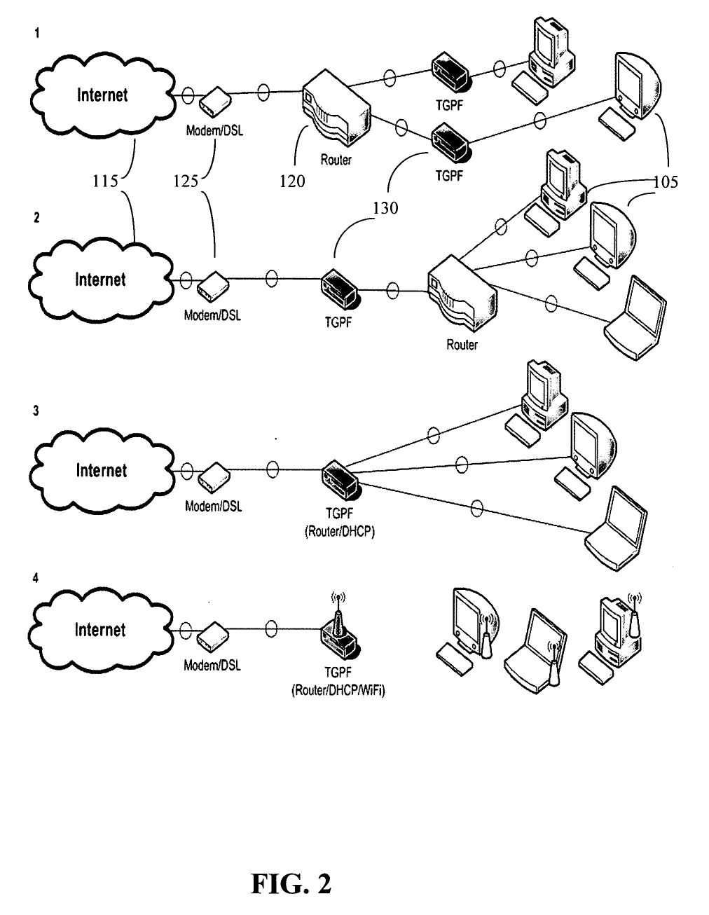

FIG. 1 illustrates a functional diagram of a standard configuration of a computer network 100, wherein a plurality of users, i.e. computers, 105 may be accessing web site 110 on Internet 115. The local network encompassing users 105 utilizes router 120, and the Internet connection is accomplished via modem or DSL connection 125. The filter of the present invention, hereinafter referred to a Time Gate Packet Filter (TGPF), 130, may be connected between router 120 and modem/DSL 125. Several possible alternate configurations are shown in FIG. 2, for example, positioning a plurality of TGPF's between the router and the users, or adding the router with or without WiFi capability to the TGPF, or having the TGPF function as a router. Accessing a Web Site 110 can be accomplished directly through a communication means such as a direct connection, an intranet, a local Internet Service Provider (ISP), or through an on-line service provider such as CompuServe, Prodigy, AOL, etc., or using wireless devices using services such as AT&T or Verizon or DSL. Each user will generally have a display device such as a monitor and an input device such as a keyboard. This display and input device could be a PDA such as a Blackberry.

The users 105 contact Web site 110 using an informational processing system (Client) capable of running an HTML-compliant Web browser such as Internet Explorer, Netscape Navigator, Lynx, etc. A typical system that is used is a personal computer with an operating system such as Windows 95, 98, or ME, NT, 2000, McIntosh, or Linux, running a Web browser. The exact hardware configuration of computer used by the Users 105, the operating system or the Web browser configuration is not central to this invention. Any HTML-compatible Web browser is within the scope of this invention and its claims. User 105 can also access the Internet through voice and e-mail, as well as by any other standard or new form of communication.

The system will enable different modes of input devices for interaction such as keyboard, touch-screen, fax, audio, cell phones, pda, etc., and will output information on appropriate displays such as video terminals, e-mail, fax, audio, cell phones, etc. Output can include a screen, a graphical user interface, hardcopy, facsimile, e-mail, messaging or other communication with any humanly or machine discernable data and/or artifacts. The data processing system for the current invention includes a computer processor for processing data, storage for storing data on a storage medium, and communication means for transferring data in a secure environment. The system can be set up to be run on a computing device. Any general purpose computer with an appropriate amount of storage space is suitable for this purpose. The computing device can be connected to other computer devices through a communication interface such as the Internet, a Wide Area Network (WAN), telephone network, or a private Value Added Network (VAN). The storage and databases for the system may be implemented by a single database structure at an appropriate site, or by a distributed database structure that is distributed across an intra or an Internet network.

It should be appreciated that many other similar configurations are within the abilities of one skilled in the art, and all of these configurations could be used with the method of the present invention. Furthermore, it should be recognized that the computer system and network disclosed herein can be programmed and configured by one skilled in the art in a variety of different manners to implement the method steps described further herein.

An inventive aspect of the present system is that the TGPF is a stand-alone box that does not require a computer to configure, is self-contained, and has an embedded Open-Source Operating System. To implement this aspect of the invention a User Interface (UI), part of the stand alone box, is used to access and configure the box via a serial, parallel, or USB port. A driver is created to interface the LCD display on the stand-alone box with the system board of the box to allow configuration of the TGPF box. It is not necessary to use a computer, through the web browser or the serial port, to set it up. Furthermore, no software needs to be installed on the user's computer, which allows a user without technical expertise to set up and configure the inventive system.

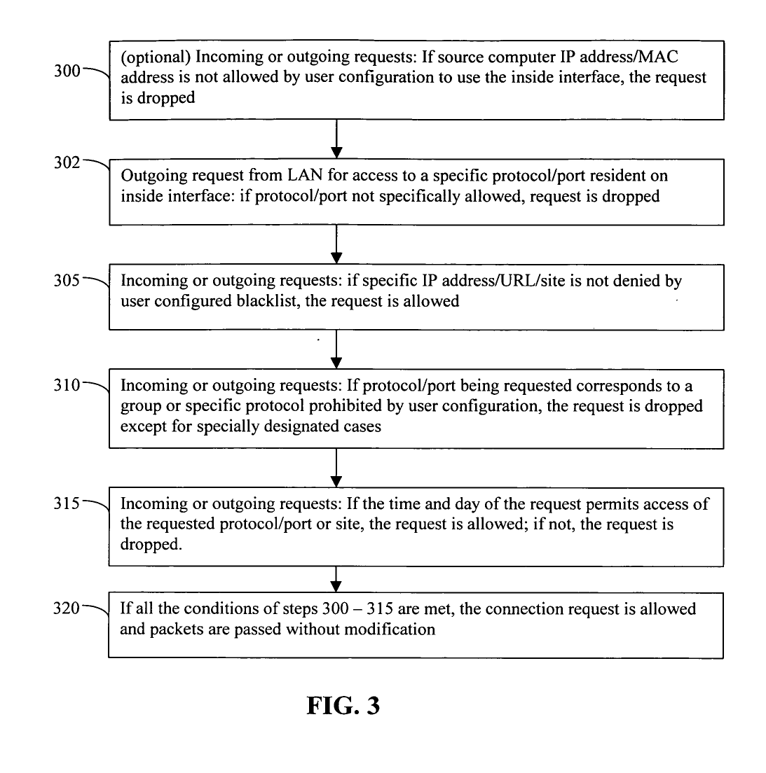

Another inventive aspect of the present system is the multi-phase filtering (in a preferred embodiment, five-phase filtering) which includes time programmability, preferably as a separate filtering phase. FIG. 3 is a flow diagram of the five phase filtering of a preferred embodiment of the present invention.

Phase 0 (step 300) is an optional filtering phase which determines, based on the user configuration, whether the source computer IP address or MAC address is allowed to use the inside interface. If this condition is not met the request is dropped. For example, using this filter, parents' computers may be allowed to use Internet, while the childrens' computers are not allowed, or are allowed with limitations.

Phase 1 (step 302) is, for an outgoing source request from the LAN for access to a specific protocol/port resident on an “inside” interface, i.e., on the PC on the LAN, based on apparatus connectivity and system considerations: If the specific protocol/port is not specifically listed as allowed, it is blocked. If this condition is not met the request is dropped.

Phase 2 (step 305) allows specific sites to be blocked by the user, such as MySpace or YouTube, as was mentioned earlier. There may be “blacklisted” IP addresses URL's which are not allowed. The filter phase comprises: if the site is denied by the blacklist then drop, else allow request. In other words, if the site is not blacklisted the request is allowed. This can apply to both incoming and outgoing requests.

Phase 3 (step 310) determines, based on the user configuration, whether the protocol being requested is allowed on a particular port, either independently, or according to its group/category. In other words, does the protocol/port being requested correspond to a group prohibited by the filter as configured by the user, or a specific prohibited protocol? If this condition exists the request is dropped except for specially designated cases, as described below. This filtering phase allows certain classes of sites or applications which may use certain protocols or protocol groups to be blocked, such as chat rooms. The blocking mechanism completely blocks port/protocol combinations within categories according to the user configuration, and allows only certain particularly specified combinations within those categories. For example, if protocol/port combinations corresponding to games are blocked, the user can select certain specific games or specific game categories to be allowed, such as the educational game category in general, or MathBlaster in specific. This filter applies to both incoming and outgoing requests.

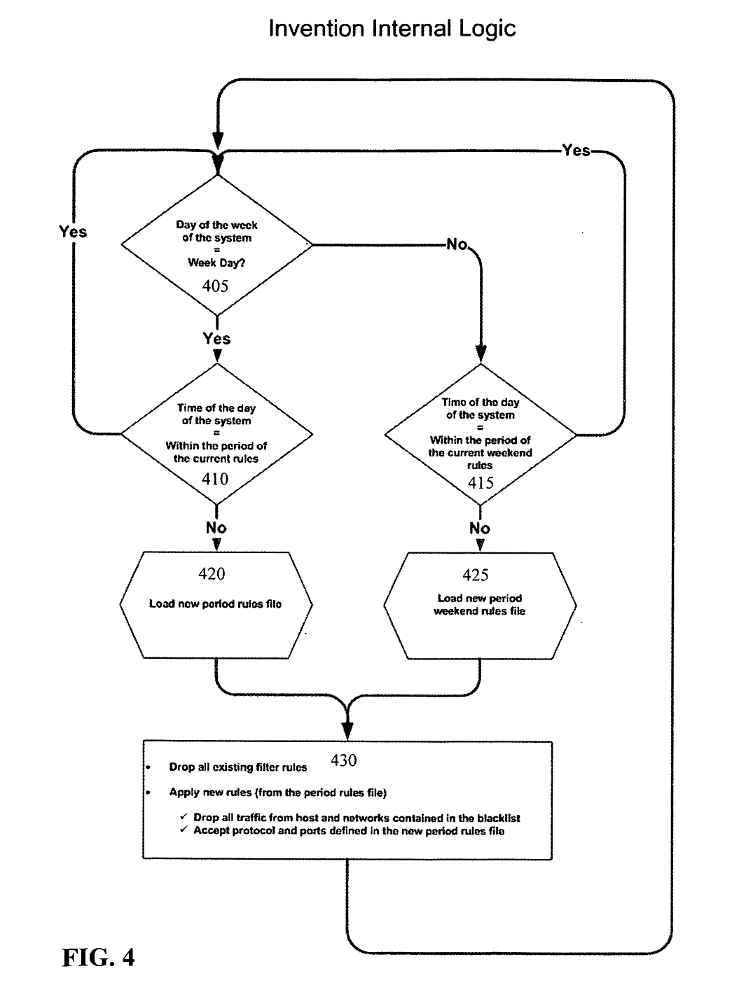

Phase 4 (step 315) determines, based on the 24 hour clock and a weekly schedule, as set up by the user, whether the time and day of the request permits access of the requested protocol/port or site. If this condition is not met the request is dropped. The functioning of the time phase filtering involves uploading the rules for a time period each time the time period changes. An exemplary software program implementing this operates according to the flow chart of FIG. 4:

In step 400 a request is received.
In step 405 the weekday status of the system is determined. If yes (i.e., it is a weekday), go to step 410. If no (i.e., it is a weekend), go to step 415. In step 410 it is determined if the time of day of the system falls within the period of the current weekday rules as configured by the user. If yes, loop back to the beginning. The time can be checked at user-determined intervals. If no, go to step 420, where a new period weekday rules file is loaded. In step 415, it is determined if the time of day of the system falls within the period of the current weekend rules as configured by the user. If yes, loop back to the beginning. If no, go to step 425. In step 425, a new period weekend rules file is loaded. After both step 420 and 425, go to step 430: 1) Drop all existing filter rules; 2) Apply new rules from the appropriate new period rules file. This includes dropping all traffic from the host and networks contained in the blacklist, and accepting the protocol/ports as defined in the new period rules file.

Phase 5 (step 320): If all of the conditions of phases 1-4 are met, the connection request is allowed and packets are passed without modification.

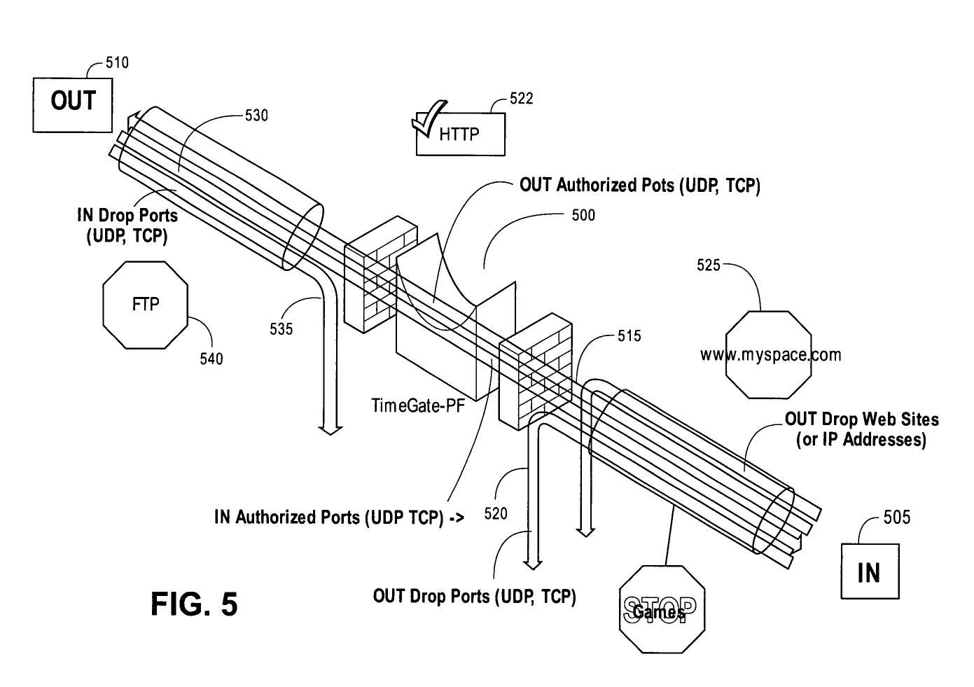

FIG. 5 illustrates an exemplary configuration of the TGPF as it controls access to different types of data flow. TGPF 500 is positioned between user computer 505 and internet 510. Outgoing data 515, including authorized ports for such protocols as UDP, TCP pass through TGPF 500, but outgoing ports 520, not authorized for UDP and TCP, are dropped. Furthermore, the games category of protocols/ports is blocked. Http white-list symbol 522 indicates that http is allowed for all ports. Likewise, outgoing Web sites or IP addresses 525, in this case www.myspace.com, are dropped for all ports, i.e., blacklisted. This may apply to all computers in the network, or could be configured for each computer. There is a trade-off between ease of configuration and more complex functionality. Incoming data 530, including authorized ports for UDP, TCP, pass through TGPF 500, but incoming port 535, not authorized for UDP and TCP, is dropped. Blacklist symbol 540 indicates that FTP is blocked for all ports.

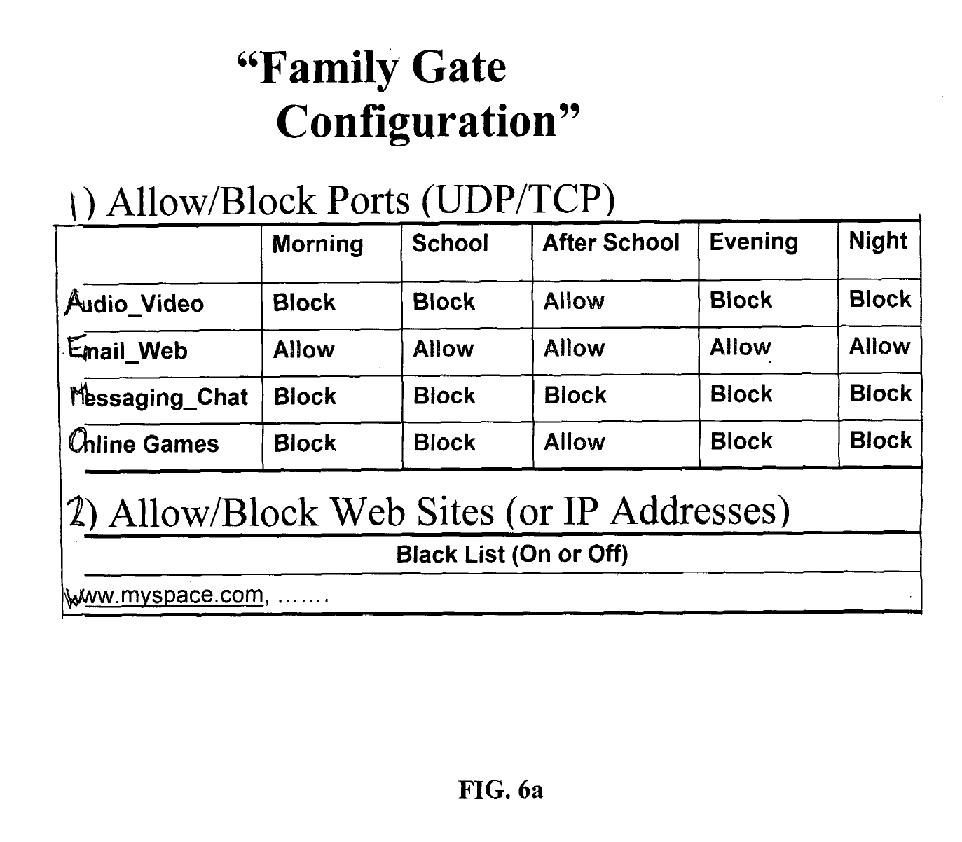

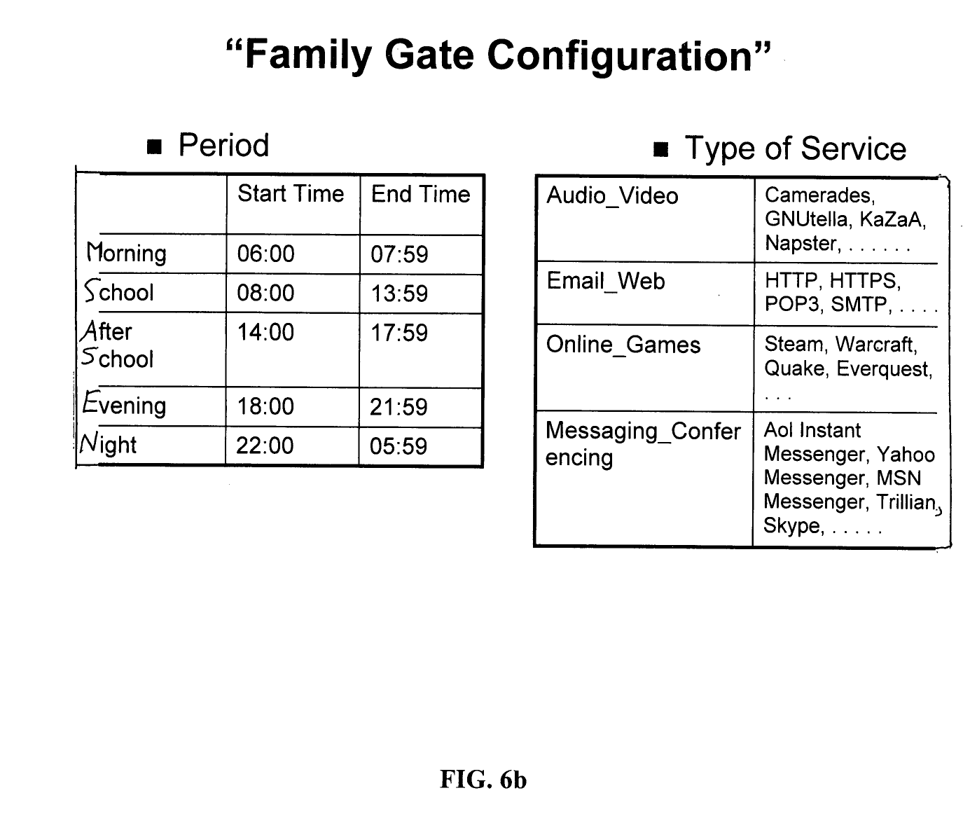

FIG. 6a illustrates an exemplary configuration for family usage. Other potential types of configurations include business gate configuration and school gate configuration. All of the configurations limit access based on time period, type of service protocol/port combination, URL's, and may include the particular computer. The hours corresponding to the different time periods are synchronized to a clock, generally the internal system clock, and set by the user or automatically. The user does not need to know the details of the blocking mechanisms, the user simply configures the box according to the categories or specific sites to be blocked. FIG. 6b illustrates exemplary settings corresponding to the family gate configuration of FIG. 6a.

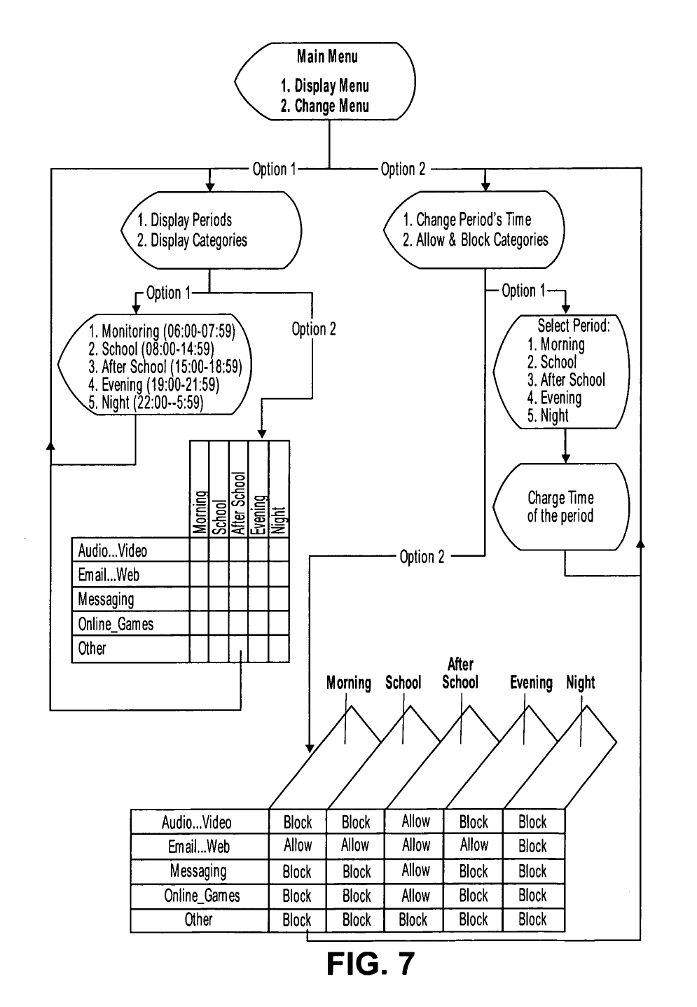

FIG. 7 is a flow chart showing the menu flow.

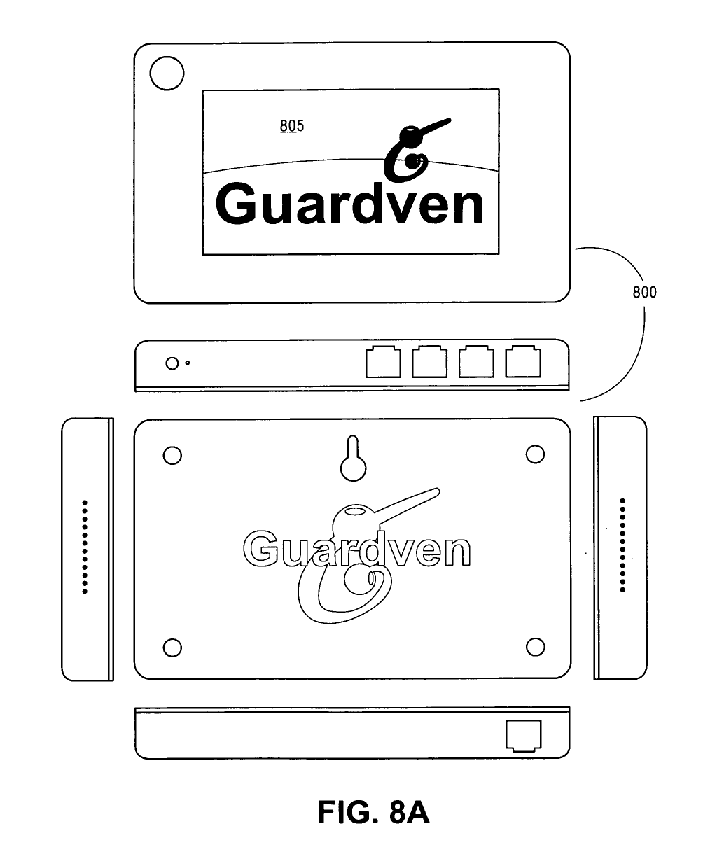

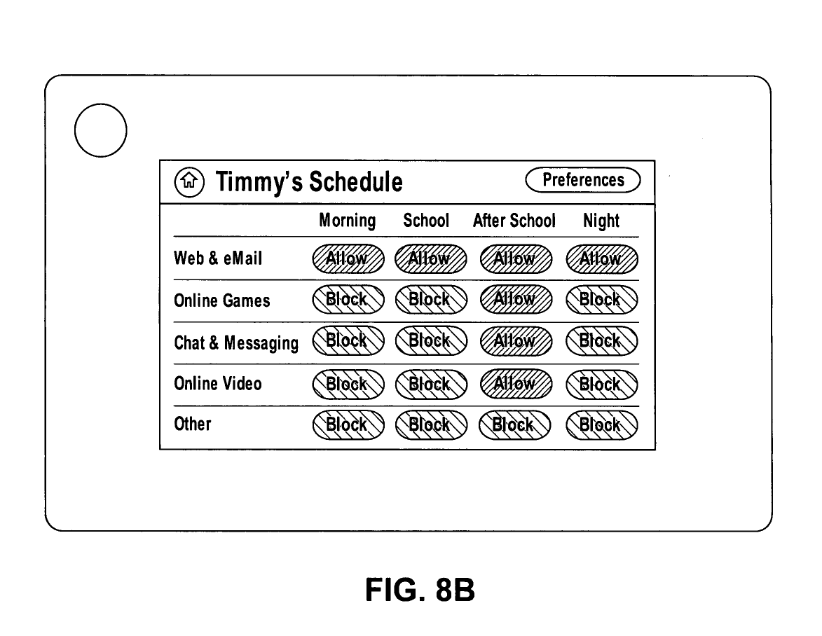

FIGS. 8a and 8b show the hardware components of the inventive box. FIG. 8a shows rectangular control box 800 with display screen 805 (a preferred embodiment of the invention utilizes a touch screen) wherein the menu may appear as shown in FIG. 8b. Other types of inputs for programming the box may be used.

With respect to the above description, it is to be realized that the optimum dimensional relationships for the parts of the invention, to include variations is size, materials, shape, form, function and manner of operation, assembly and use, are deemed readily apparent and obvious to one skilled in the art, and all equivalent relationships to those illustrated in the drawings and described in the specification are intended to be encompassed by the present invention. Moreover, those skilled in the art will appreciate that the invention may be practiced with other computer system configurations, including handheld devices such as PDA's multiprocessor systems, microprocessor-based or programmable consumer electronics, network PC's minicomputers, mainframe computers, and the like. The invention may also be practiced in distributed computing environments where tasks are performed by remote processing devices that are linked through a communications network. The specific details of the breakdown of the filtering phases may be changed.

Therefore, the foregoing is considered as illustrative only of the principles of the invention further, since numerous modifications and changes will readily occur to those skilled in the art, it is not expected that the invention is to be limited to the exact embodiments disclosed herein. The scope of the invention should be construed in view of the claims.

With this in mind, I claim:

1. A stand-alone filter system configurable to control data flow between at least a computer and an external network, said stand-alone filtering system connected between said at least a computer and said external network.

2. The filter system of claim 1 configured to provide filtering of said data flow, wherein said filtering includes time filtering.

3. The filter system of claim 2 configured such that said filtering is multi-phase filtering, at least one of said phases including time filtering.

4. The filter system of claim 3, configured such that said time filtering constitutes a filtering phase.

5. The filter system of claim 1, configured such that said filtering includes protocol/port filtering.

6. The filter system of claim 1, configured such that said filtering includes filtering of specific URL's/web sites.

7. The filter system of claim 1, configured such that said filtering is organized by user-determined Internet access categories.

8. The filter system of claim 3, wherein said data flow includes a request from a source to a destination, said request being pursuant to a protocol, wherein said multi-phase filtering includes:
a) a filtering mechanism configured to allow an outgoing request only if said request has access to a specific protocol resident on an inside interface, based on apparatus connectivity and system considerations;
b) a filtering mechanism configured to allow a request for data to flow between a user computer and a specific site/URL unless, based on a user configuration, said specific site/URL is denied.
c) a filtering mechanism configured to allow a request for data to flow between a user computer and the Internet pursuant to a first protocol/port unless, based on said user configuration, said first protocol/port being requested belongs to a prohibited group and is not specifically allowed.
d) a filtering mechanism configured to allow a request for data to flow between a user computer and the Internet pursuant to a second protocol/port/site only if the time and day of said request, based on said user configuration, permits access of said requested second protocol/port/site.

9. The filter system of claim 8, where each of said elements a)-d) constitutes a separate filtering phase, and further configured to include a fifth phase comprising the request is allowed and data packets are passed without modification.

10. The filter system of claim 8, further configured to include a filtering mechanism to allow a request for data to flow between a specific user computer having an IP/MAC address and the Internet only if said IP/MAC address is allowed, based on user configuration, to use said inside interface.
